(19) United States
(12) Patent Application Publication
(10) Pub. No.: US 2017/0080330 A1
(43) Pub. Date: Mar. 23, 2017

(54) LOCATION-BASED ACTIVITY

(71) Applicant: Team Action Zone Oy, Tampere (FI)

(72) Inventors: Kari Laurila, Tampere (FI); Jukka Holm, Tampere (FI)

(21) Appl. No.: 15/126,024

(22) PCT Filed: Mar. 14, 2014
(86) PCT No.: PCT/FI2014/050192

§ 371 Date: Sep. 14, 2016

(51) Int. Cl. A63F 13/216; G09B 7/06; G06K 9/00; A63F 13/79; G01C 21/36; A63F 13/35; G09B 29/10

(52) U.S. Cl. CPC A63F 13/216; A63F 13/35; G09B 7/06; G09B 29/10; A63F 13/79; G01C 21/36; G06K 9/00476; A63F 2300/8064; A63F 2300/8094; A63F 2300/204; A63F 2300/205

(57) ABSTRACT

A computer-implemented method, a system and a computer program includes processing of at least one object associated to geographic information on a first map template, wherein the at least one object defines a checkpoint related to or to be executed in the geographic location.

### FIELD

The aspects of the disclosed embodiments relate to location-based services. More particularly, the aspects of the disclosed embodiments relate to a method, system and computer program for providing management of location-based activities.

### BACKGROUND

Mobile phones with a positioning capacity have opened new possibilities to follow and monitor the action of the mobile user, for example location-based games that combine gameplay actions to a specific location have been introduced. Navigation systems are known to include Point-of-Interest (POI) data in databases.

The current systems operate in a single layer, for example the map wherein the location of the user is indicated is kept similar during the whole operation of the location-based activity. The systems are usually static; there is no easy solution to manage the map template or a single activity.

### SUMMARY

The aspects of the disclosed embodiments are directed to a computer-implemented method comprising facilitation of processing of and/or processing of data and/or information and/or at least one signal, the data and/or information and/or at least one signal based, at least in part, on the following: processing of at least one object associated to geographic information on a first map template, wherein the at least one object defines a checkpoint related to or to be executed in the geographic location. A map template is a graphical illustration comprising points that correspond to geographical locations. The checkpoint refers to an object that is associated to the geographic information enabling the user of the mobile computer, such as the mobile phone, to reach the checkpoint by moving to the geographic location. In one embodiment the checkpoint is activated as a response to a device being detected in the geographic location. Said device is a mobile computer with means for identifying its position by interacting with its surroundings or comprising a positioning function such as a GPS or location related information such as a WLAN, Wi-Fi or Bluetooth. The checkpoint is activated by the positioning information received from the mobile device such as a mobile phone. The positioning may use altitude information to enhance the effect of the checkpoint. The checkpoint functionality may be different at different altitudes, for example at sea level or at the mountains. In one embodiment the checkpoint is activated by a local marker such as a QR code that is presented to the mobile device. In one embodiment reading the QR code with the mobile device centralizes the map view of the mobile device to the QR code location known in the map template or in the Activity. This enables the user of the mobile device to visualize the map and the correct position without any other positioning means.

In one embodiment the checkpoint causes switching of the visual representation of the first map template in the user interface view to a second map template. The user interface view of the second map template is implemented at least in the mobile computer held by the user who has a user profile in the system. One example of such transition of the map template occurs when the geographic location is an entrance to a specified area. The specified area is for example an interior area or entrance to an outdoor location such as an amusement park or attraction. In this example the entrance or the area near the entrance is assigned as a checkpoint. Detecting the checkpoint causes an outdoor map template to be replaced by an indoor map template, when the user is going inside. Respectively, the indoor map template is replaced by the outdoor map template when the user is going outside. The map template switching may be executed by any positioning method or for example by reading a QR code with the mobile device. The map template causes the mobile device to utilize a suitable positioning method. For example outdoors the GPS application interface may be used, whereas indoors a QR code may be used to position the mobile device. The map template switching may be between two outdoor maps; for example, when the user enters an amusement park area the map template switches from a general map template to a specific amusement park map template with specific ride and attraction information or visualization. The present invention enables navigation between more than one map templates. In one embodiment the transition between map templates is seamless; the mobile device entering the checkpoint is configured to switch to another map template and continue the navigation on another map template.

In one embodiment the checkpoint is activating an Activity. The Activity refers to a track comprising Tasks, checkpoints, Connections and Routes. An Activity template refers to a modifiable Activity that is launchable for the user to be experienced by the user. may be for example area info, a guided walk, a treasure hunt, a marketing campaign, a realtime competition or an interactive story. In one embodiment the Activity comprises checkpoints that may contain multimedia, information, interactive challenges, questions or route choices. Checkpoints may be chained to Activities; in one example the Activity is opened or activated only after reaching a checkpoint.

In one embodiment the checkpoint is visible in the user interface view of a mobile device to the user account fulfilling a predefined criterion. In one embodiment the visual appearance or the action related to the checkpoint changes according to the number of times the user enters the checkpoint. For example the checkpoint implemented on a racetrack may provide a different functionality as the checkpoint is entered or passed during each lap. In one example the checkpoint is visible to a predefined number of users; for example, the first 50 users arriving to the checkpoint are allowed to see the checkpoint on the mobile device; for all other users the checkpoint remains hidden. According to one embodiment the checkpoint or the Activity is visible if the user has purchased a right to see the checkpoint or the Activity. In one embodiment the checkpoint is activated at a predetermined time. The checkpoint is configured to be visible to the mobile device at a predetermined time. This may be used to open the checkpoint for a certain time period, for example for the opening hours. The system according to the present invention may assign a point calculation scheme for the user profile, wherein the points gathered by the user profile open new features. In one embodiment the checkpoint is visible in the user interface view of a mobile device according to a number of points assigned to the user account of the user profile. Examples of the predefined criteria are time, completed payment, received token or voucher. For example, the checkpoint becomes visible after the predefined criterion is met. The checkpoint may then be configured to activate the Activity. This arrangement enables payable services related to Activities. For example, the service may provide a discount to a specific service, such as lunch or dinner or a free hamburger meal.

In one embodiment the first or second map template comprises at least two objects associated to geographic information, each defining a checkpoint and a graph of the checkpoints. In one embodiment the first or second map template comprises at least two objects associated to geographic information, each defining a checkpoint and the graph of the checkpoints, the at least two objects forming an Activity template. In one embodiment the graph of the objects and the related checkpoints are assigned according to the capacity of the checkpoint. If one checkpoint is becoming crowded by simultaneous users arriving to the checkpoint, the system according to the invention assigns a portion of the users or users departing from the previous checkpoint to a different checkpoint.

In one embodiment the method comprises copying the first Activity template related to the first map template to a second Activity template and associating the checkpoints of the second Activity template to another geographical information or geographical location. The Activity template comprises at least one graph comprising checkpoints and relations between different checkpoints—in some embodiments a specific order between the checkpoints. Creating the Activity template requires a lot of effort of the designer of the Activity template, as the template comprises multiple objects, properties and relations. The Activity template is copied by maintaining the relations between objects and reassigning the geographical relations to the second location. In one embodiment the first Activity template is copied to a new location, wherein only one point, for example a center point, of the template is assigned to geographical information and the rest of the first template is managed in relation to the center point. When the second Activity template position is fixed, all remaining objects are assigned to related geographical information. In one embodiment the method comprises copying the geographical information associated to the checkpoint according to the GPS information of the object and transferring the GPS information to match the geographical location on the second map template.

In one embodiment the method comprises detecting on the second map template an area not suitable for the checkpoint, repositioning the checkpoint on the nearest suitable position on the second map template and maintaining the relative association to the next or to the previous checkpoint. For example, the checkpoint is transferred from a position indicating water to a terrain area, if the template properties indicate that water is not suitable for the Activity. Also buildings, roads or other similar objects may be assigned to be unsuitable areas.

In one embodiment the method comprises updating the objects on the first Activity template to at least a portion of the objects on the second Activity template. For example, updating a name feature or company logo presented in the first Activity template causes the second Activity template to be updated. In one embodiment the method comprises assigning to the Activity template at least one object that is not modifiable on the second Activity template with a graphical, interactive user interface object with which the user interacts in order to remove the association. Some objects or features are protected from copying or modification. The Activity template may be a result of tedious detailing, wherein some features need to be protected from modification. By enabling the modification in the user interface, for example a radio button or similar feature, the administrator may assign less experienced users rights for some minor modifications or updates. The object not being modifiable is one of the group comprising: the visibility range of the Activity zone; the size, the shape and the location of the Activity zone; the content of the task; a checkpoint type; the appearance of other users on the map template; the map template; a checkpoint icon; an image related to the Activity; or routing information to the next Activity.

In one embodiment the method comprises copying or updating at least a portion of the objects according to user rights assigned to the second Activity template. This enables the Digital Rights Management for the Activity template. The user rights are for example associated to a password, wherein the password enables the Activity, the Activity template or the map template.

In one embodiment the method comprises the Activity activating a second Activity template. An Activity may be hierarchical; for example a city street Activity template presenting only a top level view of all services, wherein entering a shop, a restaurant, an amusement park or any attraction causes a new Activity to be activated. The Activity is in one example related to the predefined criterion. A token or voucher may be used to activate the second Activity template, the second Activity template may be purchased or the second Activity template may be activated at a predefined time.

In one embodiment the method comprises temporarily removing the association between the at least one object and the geographic information with a graphical, interactive user interface object with which the user interacts in order to remove the association. This enables the functions of the Activity template to be tested virtually, removing the need for the Activity template to physically test all checkpoints. As the geographical information is temporarily removed for example by a radio button, the template designer may just click the checkpoint and visualize the action of the checkpoint.

In one embodiment the method comprises guiding the user of the Activity template to the destination via checkpoints, wherein by selecting the closest checkpoint the user is routed to the destination via further checkpoints. The navigation is based on the checkpoints. The route is assigned dynamically and the mobile computer is not required to enter all checkpoints in a predefined sequence. The network of checkpoints may be used for navigation, for example if the user of the mobile device has got lost from the predefined Activity track.

In one embodiment the method comprises generating a third checkpoint when detecting an area not suitable for moving on a route from the first checkpoint to the second checkpoint and routing the user around the area not suitable for moving from the first checkpoint to the second checkpoint via the third checkpoint. If the routing from the first checkpoint to the second checkpoint is not possible, for example if an obstacle such as a building, river or any area that does not allow trespassing is detected on the route, a third checkpoint is generated to route the user of the mobile device around the obstacle. Another example of a difficult area to be avoided is a steep hill or descent. These obstacles may be avoided completely or the system may assign a route that follows the same altitude within the hill or a route wherein the descent is within acceptable limits for moving. The third checkpoint is generated to a position that enables the obstacle to be avoided. In one embodiment more checkpoints may be generated to avoid the obstacle, for example a fourth one, a fifth one, and so on.

One embodiment of the method comprises associating the Activity template to a geographically moving platform wherein the geographical information or geographical location is periodically updated to the map template. The Activity template may be associated for example to a cruiser ship's deck plan, wherein the outdoor Activity is enabled with the mobile device's positioning feature. The map template, i.e. the deck plan in this example, is configured to move with the ship. For example two points of the map template are periodically matched to the ship's positioning information.

Another aspect of the invention discloses a system comprising at least a first computer and a mobile second computer, each comprising: at least one processor; and at least one memory including computer program code for one or more programs, the at least one memory and the computer program code operating together with the at least one processor to cause the apparatus to perform at least the following: determine that at least one device and at least one other device are executing at least one common application; cause, at least in part, synchronization of data for the at least one common application among at least the first computer and at least the mobile second computer; and process at least one object associated to geographic information on a first map template, wherein the at least one object defines a checkpoint related to or to be executed in the geographic location.

In one embodiment the checkpoint is caused to be activated as a response to the mobile second computer being detected in the geographic location. In one embodiment the checkpoint causes switching of the visual representation of the first map template in the user interface view of the mobile second computer to a second map template. In one embodiment the geographic location is near an entrance to a specified area. In one embodiment the checkpoint causes an Activity to be activated. In one embodiment a predetermined time causes the checkpoint to be activated.

In one embodiment the checkpoint is visible in the user interface view of the mobile second computer according to a number of points assigned to a user account operating on the second mobile computer. In one embodiment the checkpoint is visible in the user interface view of the mobile second computer if a predetermined criterion is fulfilled for a user account operating on the second mobile computer.

In one embodiment the first or the second map template comprises at least two objects associated to geographic information, each defining a checkpoint and a graph of the objects. In one embodiment the first or the second map template comprises at least two objects associated to geographic information, each defining a checkpoint and the graph of the objects, the at least two objects forming an Activity template.

In one embodiment the graph of the objects and the related checkpoints are assigned according to the capacity of the checkpoint. In one embodiment the first computer causes copying of the Activity template related to the first map template to a second Activity template and association of the checkpoints of the second Activity template to another geographical information or geographical location.

In one embodiment the first computer causes copying of the geographical information associated to the checkpoint according to the GPS information of the object and transfers the GPS information to match the geographical location on the second map template. In one embodiment the first computer causes repositioning of the checkpoint on the nearest suitable position on the second map template and maintaining of the relative association to the next or to the previous checkpoint, when an area not suitable for the checkpoint is detected on the second map template.

In one embodiment at least a portion of the objects on the second Activity template are caused to be updated as a result of the update of the objects on the first Activity template. In one embodiment a graphical, interactive user interface object with which the user interacts in order to remove the association causes assigning to the Activity template at least one object that is not modifiable on the second Activity template. In one embodiment the object not modifiable is one of the group comprising: the visibility range of the Activity zone; the size, the shape and the location of the Activity zone; the content of the task; a checkpoint type; the appearance of other users on the map template; the map template; a checkpoint icon; an image related to the Activity; or routing information to the next Activity.

In one embodiment at least the first computer causes copying or updating of at least a portion of the objects according to user rights assigned to the second Activity template. In one embodiment the Activity causes activation of a second Activity template. In one embodiment the association between the at least one object and the geographic information is temporarily caused to be removed with a graphical, interactive user interface object with which the user interacts in order to remove the association.

In one embodiment the selection of the closest checkpoint causes the second mobile computer with the user account to route the second mobile computer to the destination via checkpoints and causes guidance of the user account of the Activity template to the destination via further checkpoints. In one embodiment a third checkpoint is caused to be generated when an area not suitable for moving is detected on a route from the first checkpoint to the second checkpoint and caused to route the user around the area not suitable for moving from the first checkpoint to the second checkpoint via the third checkpoint.

In one embodiment the Activity template is caused to be associated to a geographically moving platform wherein the geographical information or geographical location is periodically updated to the map template.

Another aspect of the invention discloses a nontransitory computer program comprising computer program code embodied in a tangible computer-readable medium, the computer program code configured to carry out the method described herein. Typically, the present invention is implemented as a computer program, wherein the computer program is executed in a mobile device comprising suitable means for executing program code and positioning means. When the computer program is executed in a mobile device it is configured to perform the method described above. The computer program may be embodied in a computer readable medium, but in the most typical case it is downloaded from the Internet or it is installed in the mobile device before the sale.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram of an embodiment of the present disclosure,

FIG. 2 is an illustration explaining the directions of movement,

FIG. 3 is an example of routing around an obstacle.

### DETAILED DESCRIPTION

Reference will now be made in detail to the embodiments of the invention, examples of which are illustrated in the accompanying drawings.

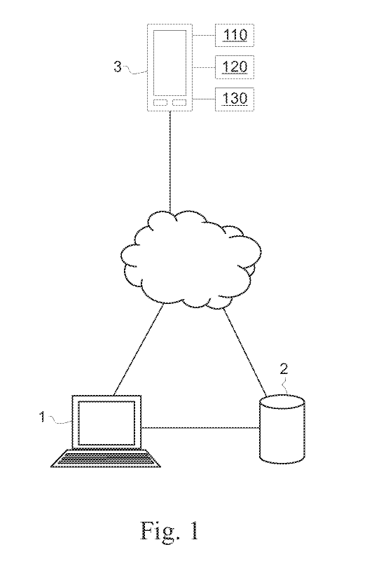

FIG. 1 illustrates one simplified example of the system according to the disclosed embodiments. The system is implemented in a cloud computing environment 4, wherein at least a first computer 1 is connected to the service platform via an IP data connection. In one embodiment the service platform 2 is implemented in the first computer 1. The first computer 1 comprises at least one processor and at least one memory including computer program code for one or more programs, the at least one memory and the computer program code operating together with the at least one processor to cause the apparatus to perform the functionalities of the invention. In this example the first computer 1 is running a program via a browser in the service platform 2.

The mobile second computer 3 is for example a mobile phone, a mobile device, a PDA, a mobile tablet, or in one embodiment a computer that is integrated into a car. The mobile second computer 3 comprises at least one processor and at least one memory including computer program code for one or more programs, the at least one memory and the computer program code operating together with the at least one processor to cause the second mobile computer 3 to perform the functionalities of the invention. The second mobile computer 3 is an apparatus for wireless communication and according to an embodiment connected to a mobile communication network. The apparatus 3 comprises at least one controller 110, such as a processor, a memory 120 and a communication interface 130. Stored in the memory 120 are computer instructions which are adapted to be executed on the processor 110. The communication interface 130 is adapted to receive and send information to and from the processor 110. The apparatus 100 is commonly referred to as user equipment or it may comprise a part of user equipment. The second mobile computer is connected to the service platform 2 or to the first computer 1 via an IP data connection, for example by a GPRS, 3G or LTE connection.

The service platform provides a solution for creating and running location-based Activities, including ‘Amazing Race’ type of games where teams compete against each other along dynamic routes. The routes can include checkpoints for example outdoors, wherein the position information is received from the mobile phone's positioning application, such as a GPS; indoors, wherein the positioning is received for example from tags such as QR, NFC or an URL link to be entered to the mobile device; or location independent checkpoints that are assigned as floating checkpoints. Indoor positioning may be dynamic; in one example the QR code is visualized on a screen such as a TV set, wherein the user of the mobile phone may receive the information provided in the QR code.

Checkpoints are destinations for the users of the mobile device or the second mobile computer to be reached. Users are guided from checkpoint to checkpoint either by verbal/photographic instruction or using the GPS technology. Different types of checkpoints include:

A GPS checkpoint is configured as a circular area on the map that is GPS sensitive. The program of the mobile device is arranged to recognize where this checkpoint is relative to its current geo-location and arranged to recognize the arrival at the GPS checkpoint to deliver the associated message.

A QR checkpoint is a checkpoint that is not GPS sensitive. These checkpoints can also be placed indoors and non-GPS instructions are displayed on the screen of the mobile device in order to guide the user to find the QR code (e.g. “You can find the next task in front of the house.”). When the camera function of the mobile device photographs the QR code, the associated task and/or any other instructions are revealed to the user. The icon used on the map template for this checkpoint is for example a red ‘pin’. In one example the QR checkpoint is arranged to open a URL link. In one embodiment the URL link may be visible at the checkpoint and the character recognition function of the mobile device is used with the camera function to read the URL link or the user may read and type the link to the mobile device.

A floating checkpoint is a checkpoint that is not located in a specific position. A floating checkpoint does not use the GPS for navigation or a QR code to verify user arrival. It is shown to the user by the user interface screen of the mobile device immediately after leaving the previous checkpoint or after selecting it in the freedom mode; thus, the user does not have to move to reach it. This enables the system to be used anywhere, even while sitting in the office, as a string of floating checkpoints can be connected together. The icon for this checkpoint is a yellow ‘pin’ to identify it on the map.

An empty checkpoint is a checkpoint which does not include any task and which can be used for guiding the user to pass a dangerous area or an area not suitable for moving. For example a bridge may be used to cross a river, wherein the empty checkpoint is generated to the bridge, thereby indicating to the user of the mobile device an obvious path. An empty checkpoint can be generated to develop a new route between two checkpoints. FIG. 3 is an exemplary illustration of an obstacle 30, for example a swamp between checkpoints 31, 32. The system generates two empty checkpoints 33, 34. Routing around the swamp 30 is directed via empty checkpoints 33, 34 using routes 35-37.

An invisible checkpoint is a checkpoint that is not visible to the user until a predetermined criterion is met. Examples of invisible checkpoints are GPS or QR checkpoints, which are not shown on the map in the map mode. The user is not guided to the checkpoint. The invisible checkpoint enables several features. For example reading the QR code opens a new checkpoint or a new Activity. In one embodiment the QR code is shown on the TV and read by the mobile device. The Activity or invisible checkpoint becomes visible as a response to the QR code. In one embodiment the predefined criterion is an electronic voucher code used in a specific location. For example a free dinner may be purchased with the voucher, wherein the system enables a new pricing for the dinner after reading the voucher.

A permanent checkpoint is a checkpoint that does not disappear from the map after the mobile device has left the checkpoint. These types of checkpoints can be used e.g. in interactive maps. An entry checkpoint is the first checkpoint of a network.

User types may be divided into administrators and teams, wherein team or members of the team move from checkpoint to checkpoint while executing the Activity. The team comprises at least one member. At the checkpoint, teams may be provided with tasks, questions, information or entertainment through their mobile phones. Points may be awarded for completing a task or finding a checkpoint.

The service platform 2 provides flexible and simple tools for arranging Activities. The user of the first computer may create and launch location-based Activities for the teams, using the online admin tool provided in the service platform 2. The Activities can then be experienced through the mobile phone's mobile application that is configured to be synchronized with the service platform 2. The Activity may be synchronized from the service platform 2 to the mobile second computer 3. For example, the user may experience the Activity offline after synchronizing the mobile device 3. After completing the Activity, the mobile device 3 may be synchronized again to receive the full functionality of the Activity or to compare the points received against other users of the Activity.

In this context, the term Activity refers to any type of a location-based track that is created on the service platform's 2 administrative site and launched for to be experienced by the users. An Activity may be, e.g., a real-time competition between several teams, a guided walk, an interactive area info, a marketing campaign, an interactive story, an educational track for a school or a university, a quiz, a track for an amusement park, a treasure hunt, a murder mystery, or almost any other type of a game that is location-dependent.

During a typical Activity, the participants move along dynamic routes, which can include GPS based, QR code based and/or location-independent checkpoints. The checkpoints can disappear after visiting or stay permanently on the map. Mobile devices guide participants to checkpoints using the following methods: text clues (e.g., “The next checkpoint is located near a big rock.”); photographic clues (e.g., a picture of the rock); conventional mapping; or cartoon mapping using custom map templates.

The user interface on the screen of the mobile device can be configured to display a guiding arrow showing the direction and the distance to the next checkpoint. Guidance can be automatic in a pre-determined sequence, activated by a deliberate choice that the participant makes, for example in the freedom mode, or delivered in a random manner as determined by the artificial intelligence element of the service platform 2. It is also possible to apply time limits to the transit time between checkpoints and the time a clue is shown before being replaced by the guiding arrow.

When arriving to a checkpoint, the participants receive tasks, questions, information or entertainment through their mobile devices. In this context, these all are referred to as tasks. The task can be triggered by one of the following methods: entering a GPS-defined area; recognizing a QR code through the camera lens of the mobile device; or entering manually a predetermined passcode; or any token provided digitally to the system. Exemplary formats of the task are: a textbased question; a numerical challenge; a multiple-choice question utilizing for example a radio button; or multiple answer questions utilizing for example a checkbox.

Each task can be scored either automatically, manually by a person at the checkpoint, or manually by a person using the administration site tools in the service platform 2. During the Activity, it is possible to follow the participants in real time via the administration site.

The map illustrating the status of the Activity, movement of the participants and scoring can be displayed/projected onto any screen to be viewed by the potential spectators. The event organizer can also chat with the participants, view the results and score individual tasks, launch participants, and ban users if they do not act according to the service policy. The event organizer may also give the participants feedback or chat during the event; in one embodiment the chat is enabled between users of the mobile devices, for example between team members. In one embodiment several simultaneous instances of the Activity are running, wherein at least part of the Activity objects are associated to the same Activity template.

In one embodiment information is shared between different Activities, enabling users of the mobile devices 3 to compete against each other for achievements inside the Activity. For example, sport fans may be gathered in different places and the present invention calculates and presents information based on the participants or their actions. Football fans supporting their teams may be collected in their home towns and the Activity is measured and displayed to both parties—for example, the town with more fans wins or the town with more completed fan based actions wins. Points can be sent to the Activity, or separate Activities may consume points from each other.

After the event, both participants and organizers can check the results on the administration site. One can also print the results in a handy format, view replays of finished Activities, etc.

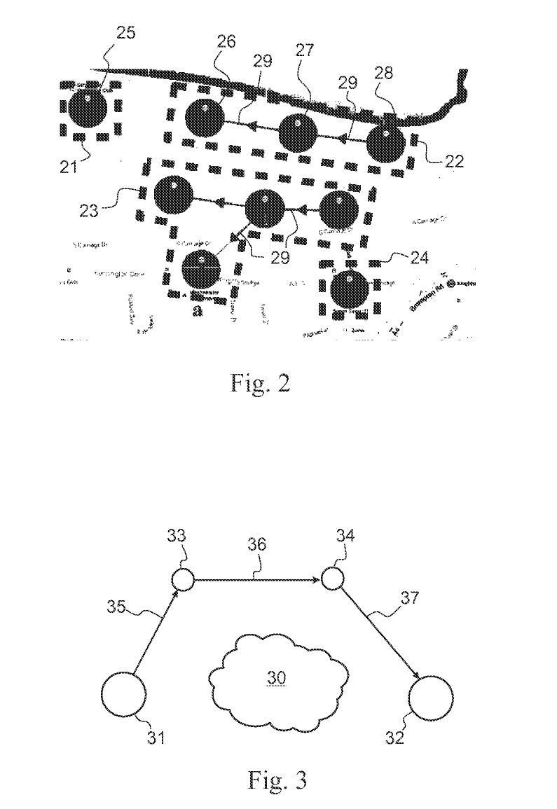

A connection between two checkpoints, or a start area and a checkpoint, is displayed on the map template as an arrow. In FIG. 2, four networks 21-24 are illustrated as an exemplary embodiment, each surrounded by a square. A network can be formed by a single checkpoint 25 or by multiple checkpoints 26-28 linked together with connections 29. Using technical terminology, networks can also be referred to as graphs.

The task is a collection of multimedia items that are shown to the user at a checkpoint. These include free text, pictures, sound, URL links to videos and different types of input fields. An on-demand task is a task that the user can ask for, and complete or pass, at any time during the Activity. These are useful for entertaining users on longer transits between checkpoints and offer an opportunity to gain more points.

A route is a path with a start and end that the user carrying the mobile device will follow. The route may contain several checkpoints and connections. The network may comprise more than one route, as illustrated in FIG. 2.

The Activity is the whole track comprising the tasks, checkpoints, connections and routes having been made. The Activity template is applied to launch a new Activity. The Activity refers to any Activity template that has been launched to be experienced by the users.

An administration site comprises service platform's online administration tools, for example the web site used for creating checkpoints, tasks and templates, launching Activities and administering them once they are launched.

An arrow guidance mode is a functionality of the client application installed on the mobile device. In this mode, the user is guided to the next checkpoint using a guiding arrow that points in the direction the next checkpoint is to be found. This mode is applied when being guided to a GPS checkpoint.

A map mode is an alternative to the arrow guidance mode. Instead of the guiding arrow, the user sees for example a traditional map template such as a Google map or a custom map with cartoon-like features and checkpoint icons that are enabled on the mobile device by the service platform. In the freedom mode, the user interface of the mobile device indicates the user to choose the network to enter. The user interface of the mobile device displays icons of entry checkpoints on a map and the user of the mobile device is able to choose from these alternatives.

Data of the service platform 2 is controlled in a manner which enables the system to be used without a continuous data network connection. In one embodiment the data connection is used only at the beginning of an Activity, when the second mobile computer 3 is connected to the service platform 2. Data required to complete the Activity is transferred from the service platform 2 to the second mobile computer 3. The second mobile computer continues the Activity even when the connection is interrupted or lost. For example answers given by the user or pictures taken during the Activity are stored in the mobile second computer 3; when the data connection is restored, the data saved by the mobile second computer 3 is sent to the service platform 2 for evaluation and scoring.

The map template Google maps may be superimposed on another map template that may comprise customized images. The custom map template may differ from the terrain map, it may for example introduce medieval features to a modern terrain, wherein the user is displayed a different digital world via the user interface of the mobile device while executing a mobile Activity.

In one embodiment the Activity template is copied to another location. The Activity template is selected, copied and pasted to another map position. The whole graph that represents the Activity is first positioned with a single pin that has correlations to checkpoints, tasks and connections. The Activity template may be rotated and scaled.

The aspects of the disclosed embodiments stores pictures taken by at least the mobile device of the user during the Activity. If there are many users taking many pictures, all pictures taken that are connected to the Activity are stored in the service platform 2. The Activity may be for example a wedding, where all guests take pictures. As a result, all wedding pictures taken during the event are stored in a single place, for example in a single folder.

In an embodiment the invention is implemented as computer software that is configured to execute the method and independent features described above when the computer software is executed in a computing device. The computer software may be embodied in a computer readable medium or distributed in a network such as the Internet.

It is obvious to a person skilled in the art that with the advancement of technology, the basic idea of the invention may be implemented in various ways. The invention and its embodiments are thus not limited to the examples described above; instead they may vary within the scope of the claims.

1-47. (canceled)

48. A computer-implemented method comprising facilitation of processing and/or processing of data and/or information and/or at least one signal, the data and/or information and/or at least one signal based, at least in part, on the following: processing of at least one object associated to geographic information on a first map template, wherein the at least one object defines a checkpoint related to or to be executed in the geographic location, and
wherein the data and/or information and/or at least one signal are further based, at least in part, on the following: the checkpoint being activated as a response to a device being detected in the geographic location.

49. A method of claim 48, wherein the data and/or information and/or at least one signal are further based, at least in part, on the following: the checkpoint being visible in the user interface view of a mobile device according to the number of points assigned to the user account.

50. A method of claim 48, wherein the data and/or information and/or at least one signal are further based, at least in part, on the following: the checkpoint being visible in the user interface view of a mobile device to the user account fulfilling a predefined criterion.

51. A method of claim 48, wherein the data and/or information and/or at least one signal are further based, at least in part, on the following: the first or the second map template comprising at least two objects associated to geographic information, each defining a checkpoint and the graph of the checkpoints, the at least two objects forming an Activity template.

52. A method of claim 51, wherein the data and/or information and/or at least one signal are further based, at least in part, on the following: the graph of the objects and the related checkpoints are assigned according to the capacity of the checkpoint.

53. A method of claim 51, wherein the data and/or information and/or at least one signal are further based, at least in part, on the following: copying the first Activity template related to the first map template to a second Activity template and associating the checkpoints of the second Activity template to another geographical information or geographical location.

54. A method of claim 53, wherein the data and/or information and/or at least one signal are further based, at least in part, on the following: copying the geographical information associated to the checkpoint according to the GPS information of the object and transferring the GPS information to match the geographical location on the second map template.

55. A method of claim 53, wherein the data and/or information and/or at least one signal are further based, at least in part, on the following: detecting on the second map template an area not suitable for the checkpoint, repositioning the checkpoint in the nearest suitable position on the second map template and maintaining the relative association to the next or to the previous checkpoint.

56. A method of claim 53, wherein the data and/or information and/or at least one signal are further based, at least in part, on the following: updating the objects on the first Activity template to at least a portion of the objects on the second Activity template.

57. A method of claim 53, wherein the data and/or information and/or at least one signal are further based, at least in part, on the following: assigning to the Activity template at least one object that is not modifiable on the second Activity template with a graphical, interactive user interface object with which the user interacts in order to remove the association.

58. A method of claim 57, wherein the data and/or information and/or at least one signal are further based, at least in part, on the following: the object not modifiable is one of the group comprising:
the visibility range of the Activity zone;
the size of the Activity zone;
the shape of the Activity zone;
the location of the Activity zone;the content of the task;
a checkpoint type;
the appearance of other users on the map template;
the map template;
a checkpoint icon;
an image related to the Activity; or
routing information to the next Activity.

59. A method of claim 53, wherein the data and/or information and/or at least one signal are further based, at least in part, on the following: copying or updating at least a portion of the objects according to user rights assigned to the second Activity template.

60. A method of claim 51, wherein the data and/or information and/or at least one signal are further based, at least in part, on the following: removing temporarily the association between the at least one object and the geographic information with a graphical, interactive user interface object with which the user interacts in order to remove the association.

61. A method of claim 51, wherein the data and/or information and/or at least one signal are further based, at least in part, on the following: generating a third checkpoint when detecting an area not suitable for moving on a route from the first checkpoint to the second checkpoint and routing the user around the area not suitable for moving from the first checkpoint to the second checkpoint via the third checkpoint.

62. A system comprising:
at least a first computer and a mobile second computer, each comprising;
at least one processor; and
at least one memory including computer program code for one or more programs, the at least one memory and the computer program code operating together with the at least one processor to cause the apparatus to perform at least the following:
determine that at least one device and at least one other device are executing at least one common application;
cause, at least in part, synchronization of data for the at least one common application among at least the first computer and at least the mobile second computer; and
process at least one object associated to geographic information on a first map template, wherein the at least one object defines a checkpoint related to or to be executed in the geographic location, and wherein the checkpoint is caused to be activated as a response to the mobile second computer being detected in the geographic location.

63. A system of claim 62, wherein the checkpoint is visible in the user interface view of the mobile second computer according to the number of points assigned to a user account operating on the second mobile computer.

64. A system of claim 62, wherein the checkpoint is visible in the user interface view of the mobile second computer if a predetermined criterion is fulfilled for a user account operating on the second mobile computer.

65. A system of claim 62, wherein the first or the second map template comprises at least two objects associated to geographic information, each defining a checkpoint and the graph of the objects, the at least two objects forming an Activity template.

66. A system of claim 65, wherein the first computer causes copying of the Activity template related to the first map template to a second Activity template and associating of the checkpoints of the second Activity template to another geographical information or geographical location.

67. A system of claim 65, wherein the association between the at least one object and the geographic information is temporarily caused to be removed with a graphical, interactive user interface object with which the user interacts in order to remove the association.
